(19) United States
(12) Patent Application Publication
(10) Pub. No.: US 2007/0235536 A1
(43) Pub. Date: Oct. 11, 2007

(54) Printer for an electronic voting apparatus

(76) Inventor: Takumi Seino, Chiba-shi (JP)

Correspondence Address: BRUCE L. ADAMS, ESQ., SUITE 1231, 17 BATTERY PLACE, NEW YORK, NY, 10004, US

(21) Appl. No.: 11/705,701

(22) Filed: Feb. 13, 2007

(30) Foreign Application Priority Data
Apr. 7, 2006 (JP) 2006-105923
Oct. 23, 2006 (JP) 2006-287227

(51) Int. Cl. G07C 13/00

(52) U.S. Cl. 235/386

(57) ABSTRACT

To provide a printer for an electronic voting apparatus which is capable of smoothly transporting a recording sheet having a free end at an end thereof with a small transport load, and which is reduced in size and is simplified in structure. Fanfold paper (16) is accommodated in a container (7) mounted on a casing (6a) of a printer (6). The fanfold paper (16) supplied into the casing (6a) from the container (7) is printed with contents of a vote inputted by a voter using a touch panel with a recording head (9), is transported to a platen roller (10), and enters a gap (12c) of a window portion (12) through a guide (13). The voter in a voting booth confirms printed contents (contents of the vote) from the window portion (12), and carries out a process of approving the contents of the vote. Then, a recording head (9) is used to print characters representing the approval, and the fanfold paper (16) is cut by a cutter portion (11). The cut portion of the fanfold paper (16) is discharged by a discharge roller (14) from a discharge opening (15), and is accommodated in a sheet-collecting member.

### BACKGROUND OF THE INVENTION

1. Field of the Invention

The present invention relates to a printer for an electronic voting apparatus.

2. Description of the Related Art

A conventional election of a municipality or the like has been conducted in such a manner that a voter writes the name of a candidate or the like of a candidate on a vote and places the vote in a ballot box. Vote counting is conducted in such a manner that each ballot box is opened, votes are taken out from the ballot box in the presence of an election official, and the votes are read with eyes one by one, to thereby count votes. Thus, the conventional election is manually conducted totally, so it takes a lot of time to count votes and check election returns, and it takes a lot of labor for operators.

In view of this, electronic voting conducted using a computer has been recently started to be adopted. An electronic voting system mainly includes electronic voting terminals each arranged in respective voting booths, and a server connected to each of the electronic voting terminals. The electronic voting terminals each include a display device (display) for displaying names or the like of candidates, and an input device used for a voter to input contents of the vote. Alternatively, a touch panel having a display device and an input device integrated therein may be used.

In the electronic voting system, electronic data (contents of votes) inputted from the input device of each of the electronic voting terminals are counted by a server, to thereby conduct the vote counting. However, it is desirable that an audit be conducted so as to confirm whether there is irregularity or falsification such as rewrite of electronic data in the voting. In order to conduct the audit, it is necessary to accommodate the contents of the votes as electronic data as well as print the contents of the votes using a printer so as to hold the contents of the votes in the form of paper. In other words, it is necessary to provide a printer connected to an electronic voting terminal.

Patent Documents 1 and 2 each disclose an electronic voting apparatus including a printer connected to an electronic voting terminal and capable of making a printed result of the printer visible in a voting booth. With the structure, the contents of the vote inputted by the voter using the input device is transmitted to a server as electronic data, and is also printed on a sheet by a printer. As a result, the voter can confirm the contents of the vote by viewing the printed result of the sheet through the window portion.

[Patent Document 1] JP 2002-230610 A

[Patent Document 2] JP 2002-279126 A

In the use of the electronic voting apparatus, it is possible that the general public votes continuously, so it is preferable to prevent the printer, which is connected to the electronic voting terminal, from running out of paper as much as possible. Accordingly, Patent Documents 1 and 2 each employ a structure in which printing is performed on a sheet of long roll paper, the voter confirms the printed contents (contents of the vote), and then the printed portion of the sheet is sequentially wound in a roll shape. However, when the paper winding method is employed, the results of the votes are printed in the order of voting, so the contents of the votes come out in the order of the voters when the wound roll paper is viewed, which arises a problem of privacy. In addition, in order to prevent the portion of the sheet on which the contents of the vote of the previous voter are printed from being viewed by the subsequent voters, it is necessary to transport the printed portion of the sheet to an outside of the window portion.

Accordingly, it is conceivable that the roll paper is sequentially cut after printing is performed thereon. In this case, the cut recording sheets may be collected, and a lot of collected recording sheets are scattered to some extent, thereby taking out the recording sheets relatively randomly. Thus, the problem of privacy is resolved. Further, the portion of the sheet on which the contents of the vote of the previous voter are printed is cut off from the roll paper and accommodated in the sheet-collecting member, which prevents the contents of the vote of the previous voter from being viewed by the subsequent voter.

However, with the structure in which the roll paper is used and cut after being printed as described above, it is necessary to provide a lot of transport rollers for transporting the roll sheet. As described above, with the structure in which the voter can view the printed result through the window portion, it is desirable that the window portion be provided between the print portion of the printer and the discharge portion of the roll paper, and the window portion be large in size in order to view the printed result more easily. The roll paper is curled because the paper is held in the roll shape, and the roll paper has a free end at an end thereof, so it is difficult to smoothly transport the roll sheet for a long distance of the window portion, and it is thus necessary to provide a plurality of transport rollers in the window portion. As a result, the electronic voting apparatus including the printer is complicated in structure and increased in size and costs.

### SUMMARY OF THE INVENTION

Therefore, it is an object of the present invention to provide a printer for an electronic voting apparatus which is capable of smoothly transporting recording sheets having a free end at an end thereof by using relatively fewer transport rollers, and which is reduced in size and is simplified in structure.

A printer for an electronic voting apparatus according to the present invention is characterized by including: a container for holding fanfold paper layered by being alternately folded every predetermined length as a recording sheet to be supplied to a casing of the printer; a print portion arranged in the casing, for performing printing on a part of the fanfold paper supplied from the container; a cutter portion arranged in the casing, for cutting off a part of the fanfold paper printed by the print portion; a window portion of the casing which is provided on a downstream side of the print portion with respect to a moving direction of the fanfold paper, through which the printed portion of the fanfold paper can be viewed from an outside; and an discharge opening of the casing provided on a downstream side of the window portion with respect to the moving direction of the fanfold paper, for discharging the printed portion of the fanfold paper which is cut off by the cutter portion.

The printer employs fanfold paper, which does not have a tendency to be curled as in the case of the roll paper, as a recording sheet, so it is possible to transport the fanfold paper for a long distance even when the fanfold paper has a free end at an end thereof. Accordingly, even when the window portion is formed in a relatively large size in order to visually confirm the contents of the vote more easily, it is not necessary to provide a transport mechanism (transport roller or the like) for transporting the recording sheet in the window portion. As a result, the printer can be reduced in size and thickness, and can be simplified in structure.

In addition, in a case where the urging mechanism for urging the fanfold paper against the bottom surface of the container is provided in the container, it is possible to suppress the increase of the transport load due to the self weight of the fanfold paper and transport the recording sheet smoothly.

Another printer for an electronic voting apparatus according to the present invention is characterized by including: a container for holding a plurality of single-cut sheets stacked as recording sheets to be supplied to a casing of the printer; a print portion arranged in the casing, for printing the single-cut sheets supplied from the container; a window portion of the casing provided on a downstream side of the print portion with respect to a moving direction of the single-cut sheets, through which the printed single-cut sheets can be viewed from an outside; and an discharge opening of the casing provided on a downstream side of the window portion with respect to the moving direction of the single-cut sheets, for discharging the printed single-cut sheets.

The printer employs a single-cut sheet, which does not have a tendency to be curled as in the case of the roll paper, as a recording sheet, so it is possible to transport the fanfold paper for a long distance. Accordingly, even when the window portion is formed in a relatively large size in order to visually confirm the contents of the vote more easily, it is not necessary to provide a transport mechanism (transport roller or the like) for transporting the recording sheet into the window portion, and in addition, it is not necessary to provide the cutter portion, so the printer can be reduced in size and thickness, and is simplified in structure.

In addition, in a case where the printer is provided with a pick-up roller arranged in the container and brought into contact with an uppermost single-cut sheet among the plurality of single-cut sheets stacked, and a support mechanism for holding the plurality of single-cut sheets stacked while urging the single-cut sheets against the pick-up roller, thereby making it possible to supply the single-cut sheet smoothly.

It should be noted that in a case where the container is mounted to the casing, the casing and the container of the printer can be handled as one unit, so it is possible to attach or detach the printer with respect to other members and maintenance work is facilitated. The container may take a posture parallel to the casing at a non-operating time of the printer for an electronic voting apparatus, and may take a posture inclined with respect to the casing at an operating time of the printer for an electronic voting apparatus. In this case, the container preferably has the bottom surface parallel with the horizontal plane at the posture inclined with respect to the casing. As a result, it is possible to suppress the increase of the sheet transport load due to the self weight of the fanfold paper or the single-cut sheet employed as the recording sheet, to thereby transport the recording sheet smoothly.

According to the present invention, fanfold paper or a single-cut sheet is employed as a recording sheet, so there is no possibility that the sheet has a tendency to be curled as in the case of the roll paper. Therefore, even when the fanfold paper has a free end at an end thereof, it is possible to smoothly transport the fan fold paper for a long distance. As a result, it is not necessary to provide a transport mechanism, such as a roller, for supporting and transporting the recording sheet in the window portion through which the printed results can be confirmed from the outside, so the printer can be reduced in size and thickness, and is simplified in structure.

### BRIEF DESCRIPTION OF THE DRAWINGS

In the accompanying drawings:

FIG. 1 is a block diagram showing an example of an electronic voting system including an electronic voting apparatus according to the present invention;

FIG. 2A is a perspective view showing an example of a substantial portion of the electronic voting apparatus shown in FIG. 1;

FIG. 2B is a perspective view showing an example of a substantial portion of the electronic voting apparatus shown in FIG. 1;

FIG. 3A is a side view showing an example of a substantial part of a printer for an electronic voting apparatus according to a first embodiment of the present invention, FIG. 3B is a front view thereof, FIG. 3C is a plan view thereof, and FIG. 3D is a bottom view thereof;

FIG. 4 is a cross-sectional view taken along the line A-A of FIG. 3A;

FIG. 5 is a flowchart showing an example of an electronic voting method using the electronic voting system shown in FIG. 1;

FIG. 6A is a side view showing an example of a substantial part of a printer for an electronic voting apparatus shown in FIG. 3 which is operating, FIG. 6B is a front view thereof, FIG. 6C is a plan view thereof, and FIG. 6D is a bottom view thereof;

FIG. 7A is a side view showing an example of a substantial part of a printer for an electronic voting apparatus, which is not operating, according to a second embodiment of the present invention, and FIG. 7B is a cross-sectional view showing an example of the substantial part of the printer which is operating;

FIG. 8 is a cross-sectional view showing an example of a substantial part of a printer for an electronic voting apparatus according to a third embodiment of the present invention;

FIG. 9 is a cross-sectional view showing an example of a substantial part of a printer for an electronic voting apparatus according to a fourth embodiment of the present invention;

FIG. 10 is a cross-sectional view showing an example of a substantial part of a printer for an electronic voting apparatus according to a fifth embodiment of the present invention; and

FIG. 11A is cross-sectional view showing an example of a substantial part of a printer for an electronic voting apparatus, which is not operating, according to a sixth embodiment of the present invention, and FIG. 11B is cross-sectional view showing an example of a substantial part of the printer which is operating.

### DETAILED DESCRIPTION OF THE PREFERRED EMBODIMENT

Hereinafter, a description is made of embodiments of the present invention with reference to the drawings.

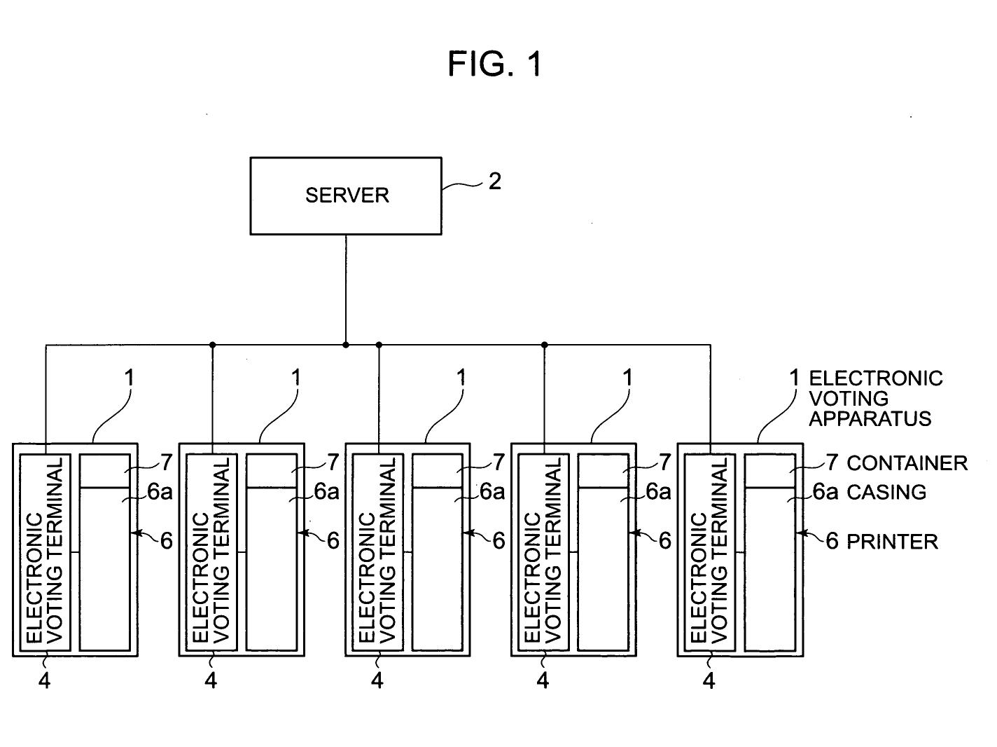

FIG. 1 schematically shows an entire structure of an electronic voting system including an electronic voting apparatus 1 according to a first embodiment of the present invention. The electronic voting system has a structure in which a plurality of electronic voting apparatuses 1 (though only five electronic voting apparatuses 1 are illustrated in FIG. 1) are connected to a server 2.

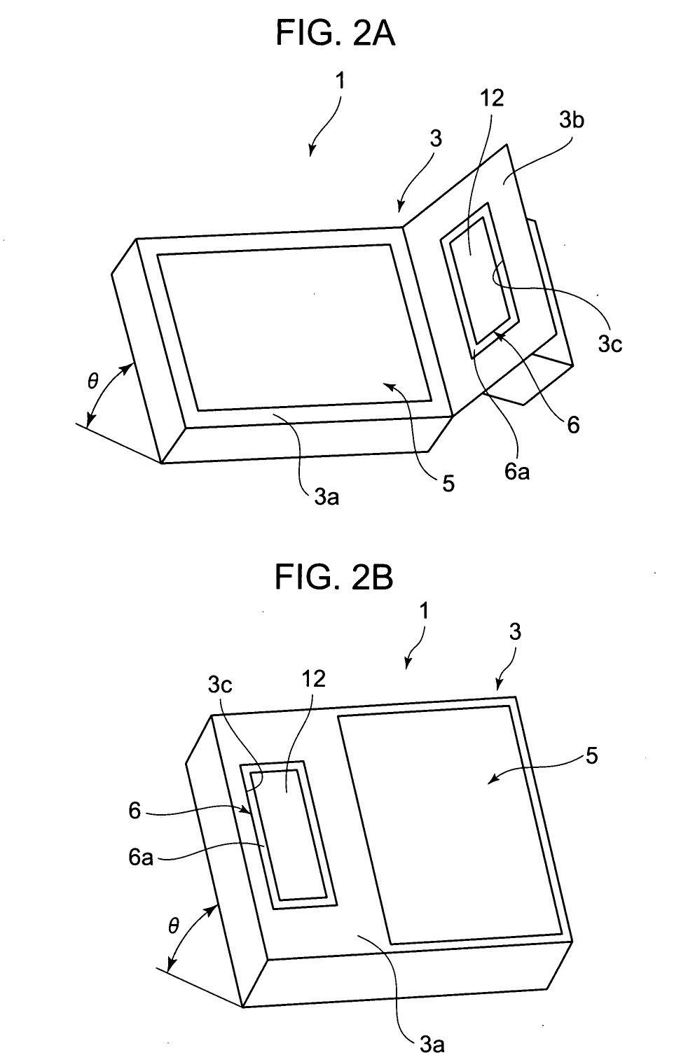

Each electronic voting apparatus 1 constitutes, as shown in FIG. 2A, a voting booth 3 including, for example, a base surface 3a and a sidewall 3b, and is provided with a touch panel 5 functioning as an display device and an input device of an electronic voting terminal 4 (see FIG. 1). In the touch panel 5, a plurality of options (for example, names of a plurality of candidates) are displayed on a display portion (display device), and an input switch (input device) corresponding to each of the options (for example, names of candidates) displayed on the display portion is touched, to thereby perform inputting of the contents of the vote. It is preferable that a shielding member is provided around the voting booth 3 so as to prevent the contents of the vote inputted to the touch panel 5 from being viewed from other persons. Further, on the side wall 3b of the voting booth 3, a printer 6 for an electronic voting apparatus is mounted. A casing 6a of the printer 6 has a window portion 12 at a position where the window portion 12 becomes exposed through a hole portion 3c provided on the side wall 3b. A detailed structure of the printer 6 is described below, but the printer 6 includes a container 7 for holding recording sheets, a print portion and a cutter portion 11 that are provided in the casing 6a.

With regard to the electronic voting apparatus 1, an angle made by the entire voting booth 3 including the printer 6 shown in FIG. 2A with respect to a horizontal plane can be adjusted by a pivoting mechanism (not shown). This adjustment is made so as to freely move and hold the touch panel 5 to a posture at which handicapped voters or voters with various heights can operate the electronic voting apparatus as easily as possible.

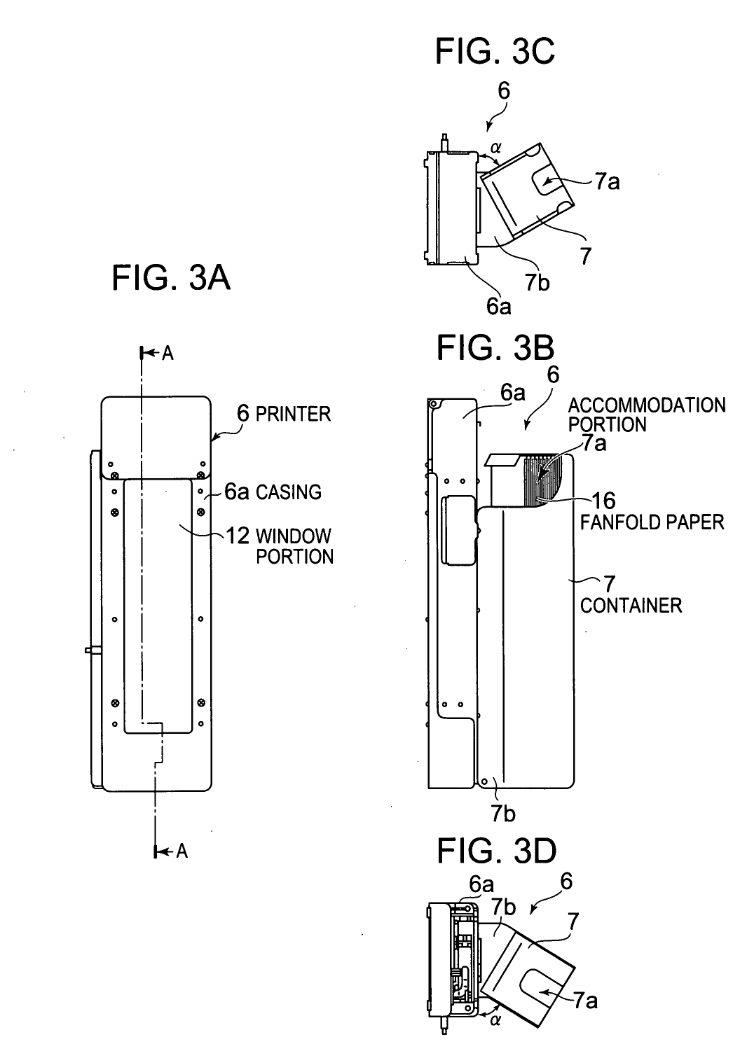

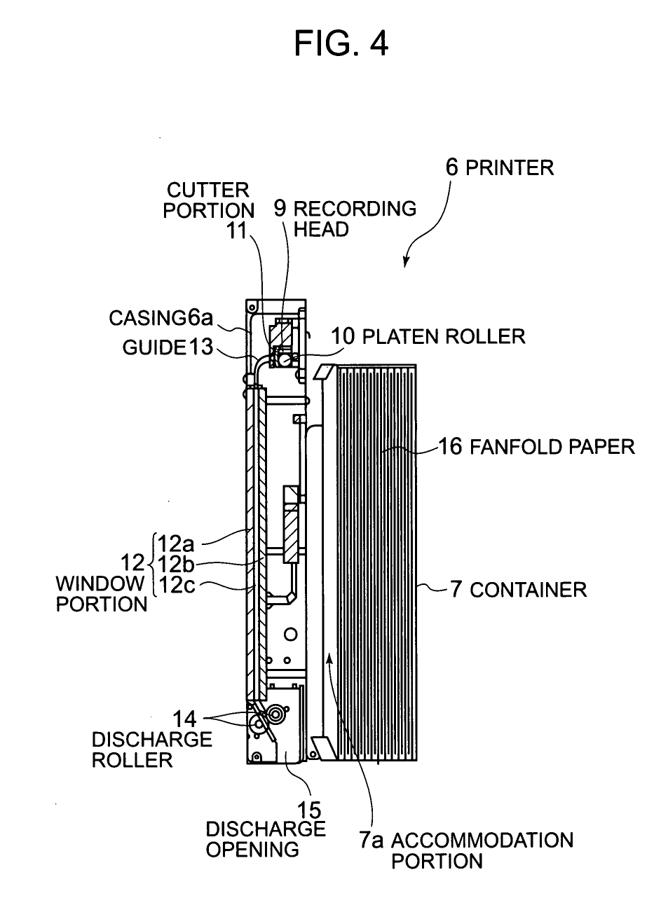

Next, as shown in FIGS. 3 and 4, the printer 6 of the electronic voting apparatus 1 according to this embodiment is described in detail. The printer 6 includes the casing 6a mounted on the side wall 3b of the voting booth 3, and the window portion 12 provided on a surface of the casing 6a which becomes exposed to the voting booth 3. The container 7 is mounted on a surface of the casing 6a on the opposite side of the window portion 12.

FIG. 4 shows the structure of the inside of the casing 6a of the printer 6. In the casing 6a, a recording head (for example, thermal head) 9 for performing printing on the recording sheet is provided. The recording head 9 is positioned upward when the printer 6 is mounted on the side wall 3b of the voting booth 3, and is arranged so as to be brought into close contact with the vicinity of one end of the container 7 to be described later when the container 7 is mounted to the printer 6. In addition, there is provided a platen roller 10 which is arranged to be opposed to the recording head 9 and is used for transporting the recording sheet with the recording sheet being held by the recording head 9. In this case, a portion in which the recording head 9 and the platen roller 10 are provided is called print portion.

At the downstream side of the print portion with respect to the transport direction of the recording sheet, the cutter portion 11 capable of cutting the recording sheet is provided. For the cutter portion, various known structures may be employed, so the detailed description thereof is omitted. However, it is possible to employ a structure in which a stationary blade and a movable blade are opposed to each other and the movable blade is moved toward the stationary blade to cut the recording sheet.

At the downstream side of the print portion with respect to the transport direction of the recording sheet, a guide 13 for guiding the recording sheet which has passed through the print portion and the cutter portion 11 is provided. The recording sheet guided by the guide 13 is introduced into the window portion 12. The window portion 12 has a structure in which a transparent plate 12a which is arranged on a surface being exposed to the voting booth and is made of a synthetic resin (for example, polycarbonate, ABS resin, and acryl), and an opposing plate 12b which may not be transparent are opposed to each other through a small gap 12c. Accordingly, when the recording sheet introduced by the guide 13 passes through the gap 12c between the transparent plate 12a and the opposing plate 12b, the portion of the recording sheet on which printing is performed by the recording head 9 can be viewed from the outside of the casing 6a, that is, from the inside of the voting booth 3 when the printer 6 is mounted on the side wall 3b. It should be noted that within the range of the window portion 12, no transport mechanism, such as a roller, for transporting the recording sheet is provided. In addition, a discharge roller 14 and a discharge opening 15 for discharging the recording sheet are provided at the downstream side of the window portion 12 with respect to the transport direction of the recording sheet.

The container 7 includes a accommodation portion 7a which can accommodate the recording sheet and is mounted on the surface of the casing 6a of the printer 6 opposite to the window portion 12, at inclination of an angle α with a fitting frame 7b. According to this embodiment, as a recording sheet, fanfold paper 16 (which are schematically shown in FIG. 4) which is layered by being alternately folded every predetermined length is accommodated in the accommodation portion 7a.

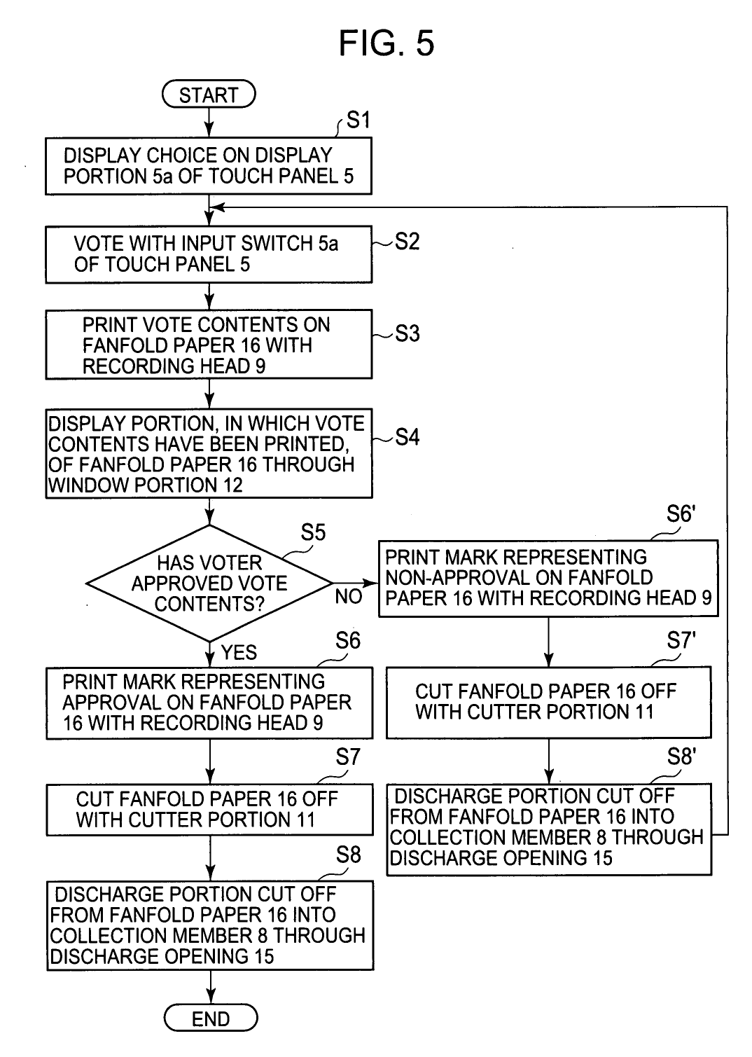

An example of a method of voting conducted using the electronic voting apparatus 1 having the above-mentioned structure is described with reference to a flowchart of FIG. 5. On the touch panel 5 of the electronic voting apparatus 1 shown in FIG. 2A, a plurality of options which are objects to be voted, for example, names of a plurality of candidates are displayed (Step S1). The voter selects any one of the options displayed on the display portion of the touch panel 5, and touches the input switch corresponding to the selected option (Step S2). Then, the electronic voting terminal 4 transmits the inputted contents, that is, data indicating the selected option, to the printer 6.

In advance, the leading end of the fan fold paper 16 accommodated in the accommodation portion 7a of the container 7 is drawn out, and is set in the print portion of the printer 6. When the data indicating the option selected as described above is transmitted from the electronic voting terminal 4 as data to be printed, the recording head 9 of the printer 6 is used to print the contents of the selected option (for example, the name of the selected candidate) on one surface of the fanfold paper 16 (Step S3). Then, the fanfold paper 16 is transported by the platen roller 10 and is introduced into the window portion 12 while being guided by the guide 13. When the portion of the fanfold paper 16 on which printing is performed by the recording head 9 reaches the gap 12c of the window portion 12, the transportation of the fanfold paper 16 performed by the platen roller 10 is temporarily stopped. In the state, the printed contents (for example, the name of the selected candidate) are displayed so that the voter in the voting booth can view the printed contents through the transparent plate 12 and the hole portion 3c of the wall 3c (Step S4).

The voter in the voting booth 3 views and confirms the printed contents (for example, the name of the selected candidate) through the window portion 12 and the hole portion 3c. When the voter approves the printed contents, the voter carries out an appropriate operation using the input portion of the touch panel 5 so as to indicate that the voter intends to determine the contents of the vote (Step S5). Upon detection of the input by the voter, the electronic voting terminal 4 transmits an instruction to print information indicating the determination of the contents of the vote to the printer 6. Then, the recording head 9 of the printer 6 is used to print, on a trailing side of the printed portion of the fanfold paper 16, characters or symbols indicating the determination of the contents of the vote, for example, “o” or “OK”, and symbols indicating the contents of the vote, for example, bar code (Step S6). After that, the cutter portion 11 cuts the fanfold paper 16 (Step S7). At this time, the portion of the sheet on which the selected contents (for example, the name of the selected candidate) are printed and the portion of the sheet on which the characters or the symbols and the bar code indicating the determination of the contents of the vote are cut off from the fanfold paper 16 into a single-cut sheet, and the single-cut sheet is transported by the discharge roller 14 and discharged from the discharge opening 15 (Step S8).

On the other hand, when there is an error in the input operation or when the voter wishes to change the contents of the vote, the voter carries out an appropriate operation, in Step S5, using the input portion of the touch panel 5 to show that the voter wishes to change the inputted contents without approving the printed contents. Upon detection of the operation of disapproval (request for change), the electronic voting terminal 4 transmits the instruction to print information indicating the disapproval of the contents of the vote to the printer 6. Then, the recording head 9 of the printer 6 is used to print, on a trailing side of the printed portion of the fanfold paper 16, characters or symbols indicating the disapproval of the contents of the vote, for example, “x” or “NG” (Step S6′). After that, the cutter portion 11 cuts the fanfold paper 16 (Step S7′). At this time, the portion of the sheet on which the disapproved contents, and the characters or symbols indicating the disapproval of the contents of the vote are printed is cut off from the fanfold paper 16 into a single-cut sheet, and the single-cut sheet is transported by the discharge roller 14 and discharged from the discharge opening 15 (Step S8′). Then, again, the voting by the voter (Step S2), the printing by the printer 6 (Step S3), and the display of the printed contents (Step S4) are performed. After that, the contents of the vote is approved in Step S5, the recording head 9 of the printer 6 is used to print, on a trailing side of the printed portion of the fan fold paper 16, the characters or symbols indicating the determination of the contents of the vote, for example, “o” or “OK”, and the symbols indicating the contents of the vote, for example; bar code (Step S6). Then, the cutter portion 11 cuts the fanfold paper 16 (Step S7) to obtain a single-cut sheet, and the sheet is discharged from the discharge opening 15 (Step S8).

When one voter completes voting through Steps S1 to S8 as described above, the electronic voting apparatus 1 is in a standby state preparing for voting by the subsequent voter. At this time, the leading end of the fanfold paper 16 is positioned in the cutter portion 11, and the fanfold paper 0.16 is not present in the window portion 12. Since the portion of the sheet on which the contents of the vote of the previous voter has been cut off by the cutter portion 11 and discharged as described above, the contents of the vote of the previous voter cannot be viewed by the subsequent voter as a matter of course. Then, the above-mentioned voting operations (Steps S1 to S8) are carried out by the subsequent voter.

In each of the plurality of electronic voting apparatuses 1, the voting operations are repeated. When the contents of the votes are transmitted as electronic data from each of the electronic voting apparatuses 1 to the server at a desired timing, a lot of contents of the votes are accommodated in the server 2 as electronic data, and at the same time, a lot of the recording sheets each of which is a single-cut sheet, on each of which the contents of the vote are printed are accommodated in each of the electronic voting apparatuses 1. When voting of all voters is completed or when a predetermined voting time elapses, the voting is closed. Then, the server 2 counts the contents of the votes transmitted from each of the electronic voting apparatuses 1. Alternatively, in the same manner as in the conventional case, the operator may manually take out and read the accommodated recording sheets of single-cut sheets one by one to count the contents of the votes. The latter counting operation may be employed for verification as a backup of the electronic counting performed by the server 2. This counting operation may be performed with respect to all the electronic voting apparatuses 1, may be performed with respect to portion of the electronic voting apparatuses 1 as needed, or may be performed only when any problem occurs at the time of vote counting by the server 2.

According to this embodiment, in the electronic voting, the voter operates the input portion of the touch panel 5 to input the contents of the vote, and then the voter can view and confirm the fanfold paper 16 on which the contents of the votes are printed through the window portion 12. Then, the contents of the vote finally approved by the voter are sent to the server 2 at the desired timing. As a result, it is possible to prevent erroneous voting due to an operation error or the like, and to deal with a change of the contents of the vote. Thus, the voter can carry out voting in a desirable manner.

Further, as the backup of the contents of votes of the electronic data, the recording sheet on which the contents of the vote are printed are generated as described above. However, since the characters or symbols indicating negative meanings such as “x” or “NG” are given to the contents of the vote which are not finally approved by the voter before being changed, the recording sheets can be ignored at the time of the manual counting operation. On the other hand, since the characters or symbols indicating positive meanings such as “o” or “OK”, and the symbols indicating the contents of the vote such as bar code are given to the correct contents of the vote finally approved by the voter, the manual counting operation can be performed precisely. In other words, on the recording sheets which are cut off into single-cut sheets, both the contents of the votes and the characters or symbols indicating approval or disapproval of the contents thereof are printed, so it is necessary to confirm the characters or symbols at the time of vote counting. Through the confirmation, it is possible to prevent a counting error even when the contents of the vote are changed.

In this structure, when the window portion 12 having a sufficient size is provided and the inputted contents are printed in a large size and displayed to fill the window portion 12, it is possible to display the contents so as to provide better viewing for almost all voters in various elections. However, in a case where the roll paper is used as the recording sheet as in the conventional case, since the roll paper is easily curled, it is difficult to smoothly transport the roll sheet having a free end at an end thereof for a long distance. Accordingly, in order to transport the roll paper while supporting the paper, a plurality of transport rollers must be arranged in the window portion 12. As a result, the thickness of the window portion 12 is increased, which increases the size of the printer 6, and the mechanism of supplying a drive force to the transport rollers provided in the window portion 12 is provided, which complicates the structure thereof. In order to prevent the transport rollers provided in the window portion 12 from interfering with the confirmation with eyes of the printed portion of the recording sheet, the transport rollers are desirably arranged at positions other than the center of the window portion 12, which raises a need for further increasing the size of the casing 6a.

In contrast, according to this embodiment, the fanfold paper 16 is used as the recording sheet. The fanfold paper 16 is obtained by being alternately folded every predetermined length, and does not have a tendency to be curled. Accordingly, even when the fanfold paper 16 has a free end at an end thereof, the fanfold paper 16 advances more smoothly between the gap 12c of the window portion 12, which eliminates the necessity of providing the transport rollers in the window portion 12. As a result, it is possible to prevent the printer 6 from increasing in size and being complicated in structure.

Then, according to this embodiment, the container 7 accommodating the fan fold paper 16 is directly mounted to the casing 6a of the printer 6. In other words, it is possible to handle the casing 6 and the container 7 in an integrated manner, that is, it is possible to handle the printer 6 as one unit including the container 7 containing the recording sheets, so attachment and detachment thereof with respect to the side wall 3b can be easily performed. Accordingly, a single printer 6 can be attached to various voting booths, and maintenance work is facilitated.

Further, according to this embodiment, the printer is mounted on the side wall 3b of the voting booth 3, but, in this case, the container 7 is arranged to be inclined by the angle α with respect to the casing 6a. This is because the increase of the transport load due to the self weight of the fanfold paper 16 is suppressed. In other words, when the fan fold paper 16 accommodated in the container 7 is arranged to take a posture upright so that the longitudinal direction thereof is approximately vertically to the direction of gravity, the self weight of the fanfold paper 16 is imposed on the folded end portions. The folded end portions cannot support the self weight of the fanfold paper 16, so the fanfold paper 16 accommodated in the accommodation portion 7a of the container 7 buckles or topples over. Then, the fanfold paper 16 is held by the self weight and the transport load is increased, so when the fanfold paper 16 is drawn from the leading end side thereof by the platen roller 10, the fanfold paper 16 is not successively sent out from the inside of the accommodation portion 7a smoothly, which may cause a sheet feeding failure. It should be noted that, even when the self weight of the fanfold paper 16 is added to the extremely thin side end surface thereof, the similar sheet feeding failure is likely to occur.

According to this embodiment, as shown in FIG. 3, the fanfold paper 16 is arranged to be inclined with respect to the direction of the self weight, thereby making it possible to take a posture at which the self weight of the fanfold paper 16 is mainly added to a printable large-area flat surface (main surface). Most part of the self weight of the fanfold paper 16 is supported by the large-area flat surface as described above, so it is possible to prevent the fanfold paper 16 from buckling or toppling over in the accommodation portion 7a of the container 7, to suppress the increase of the transport load due to the self weight, and to transport the fanfold paper smoothly.

It should be noted that, as shown in FIG. 2B, in a case where the printer 6 is not mounted on the side wall 3b of the voting booth 3 but is mounted on the base surface 3a, even when the container 7 is not arranged to be inclined by the angle α with respect to the casing 6a, the increase of the transport load due to the self weight of the fanfold paper 16 hardly becomes a problem.

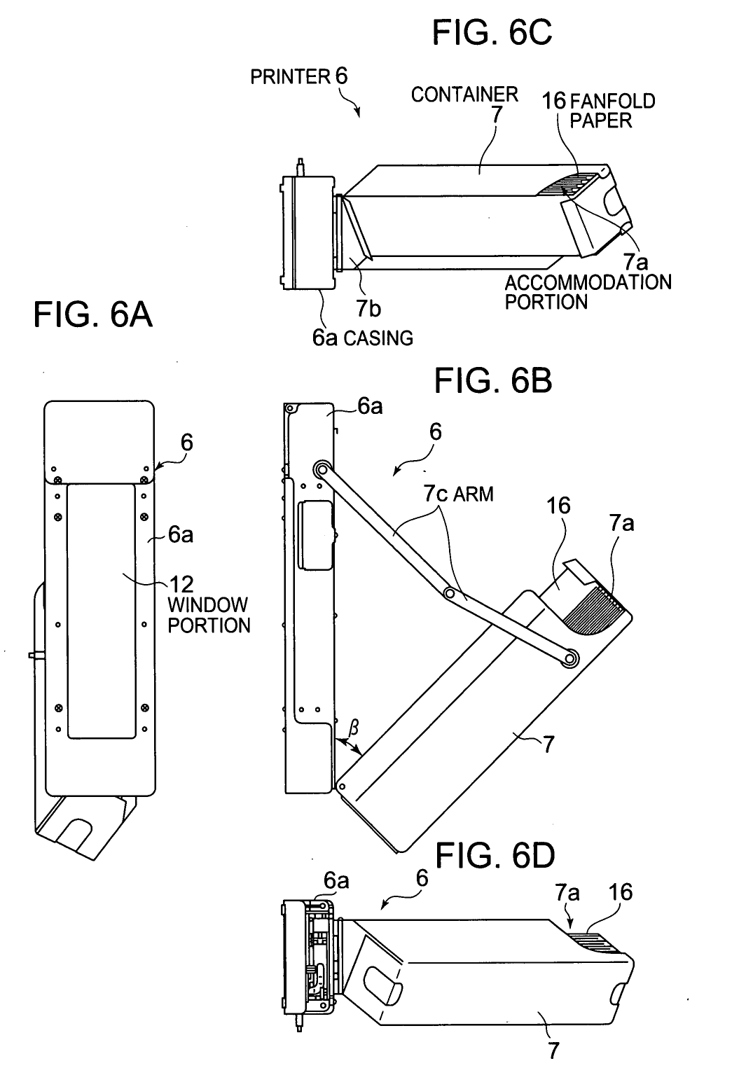

Further, as shown in FIG. 6, by the arm 7c, the fanfold paper 16 is inclined by an angle β also in the direction perpendicular to the inclination direction shown in FIG. 3, thereby making it possible to prevent the fanfold paper 16 from buckling or toppling over in the accommodation portion 7a. In particular, as shown in FIG. 2A (FIG. 2B), the adjustment of the angle θ of the electronic voting apparatus 1 including the base surface 3a and the container 7 is possible, so there is a possibility that, when the posture (angle θ) is changed, the self weight of the fanfold paper 16 is added to the folded end portions or the side end surfaces thereof, to thereby cause buckling or toppling over of the fanfold paper 16. In view of the inclination of the electronic voting apparatus 1 within a range in which the angle is adjusted, in any range of the angle, the fanfold paper 16 is inclined and held so that the self weight of the fanfold paper 16 is hardly added to the folded end portions or the side end surfaces and is mainly added to the large-area flat surface (main surface), that is, so that the fanfold paper 16 in the longitudinal direction becomes approximately orthogonal with respect to the direction of the self weight, thereby making it possible to prevent the buckling or toppling over of the sheet due to the self weight and the increase of the transport load. As a result, the whole fanfold paper 16 can be transported smoothly. In other words, the angle α and the angle β are preferably set such that the self weight of the fanfold paper 16 is hardly added to the folded portions or the side end surfaces and added to the flat surface (main surface) with the large area, in a range in which the angle of the electronic voting apparatus 1 including the base surface 3a and the container 7 is adjusted.

It should be noted that at the non-operating (accommodated) time of the printer 6, the arm 7c may be folded, the container 7 may be held as shown in FIG. 3, and at the operating (used) time of the printer 6, the arm 7c may be extended to incline the container 7 by the angle β to be held as shown in FIG. 6.

As described above, according to this embodiment, the fanfold paper 16 is used, and the container 7 containing the fanfold paper 16 is inclined with respect to the casing 6a to be held, thereby making it possible to smoothly transport the recording sheet.

It should be noted that in the structure shown in FIG. 4, the recording head 9 is brought into extremely close contact with the cutter portion 11, so even when the fanfold paper is not wound back after being cut, the subsequent printing can be performed in the vicinity of the leading end of the fanfold paper 16 remaining after being cut, and needless margins are hardly produced. It should be noted that the portion of the fanfold paper 16 on which the contents of the vote taken by the previous voter is cut by the cutter portion 11 and discharged from the discharge opening 15, so it is impossible to identify the voters who vote using the recording sheets, and the subsequent voter cannot view the contents thereof.

Next, other embodiments of the present invention will be described. Note that components identical with those according to the first embodiment are denoted by the same reference symbols, and explanations thereof are omitted.

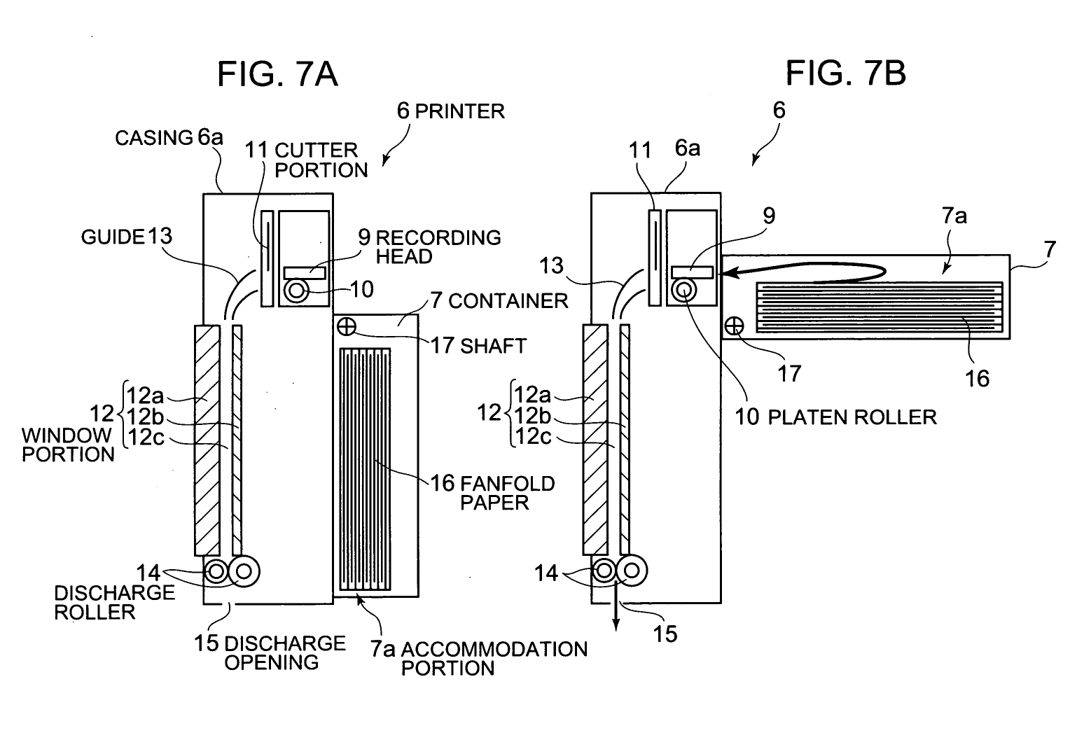

FIG. 7 shows a printer 6 for an electronic voting apparatus according to a second embodiment of the present invention. The container 7 of the printer 6 is pivotable about a shaft 17. At the non-operating (accommodated) time of the printer, the container 7 is brought into close contact with the casing 6a as shown in FIG. 7A, and at the operating (used) time of the printer 6, the container 7 is horizontally held as shown in FIG. 7B. In other words, in the structure, the angle formed by the container 7 according to the first embodiment is changed. With the structure, the large-area flat surface (main surface) of the fanfold paper 16 is arranged orthogonally to the direction of the self weight at the operating time of the printer 6, so even when the posture of the electronic voting apparatus 1 is changed as described above, the self weight is added not to the folded end portions or the side end surface but to the large-area flat surface (main surface) of the fanfold paper 16, thereby making it possible to hold the fanfold paper 16 without buckling or toppling over by the self weight and transport the whole fanfold paper 16 with a small transport load. In addition, at the non-operating time of the printer 6, the container 6 is made upright, which eliminates needless space. It should be noted that the other structures are the same as those of the first embodiment so the electronic voting method is also the same as that of the first embodiment (see FIG. 5).

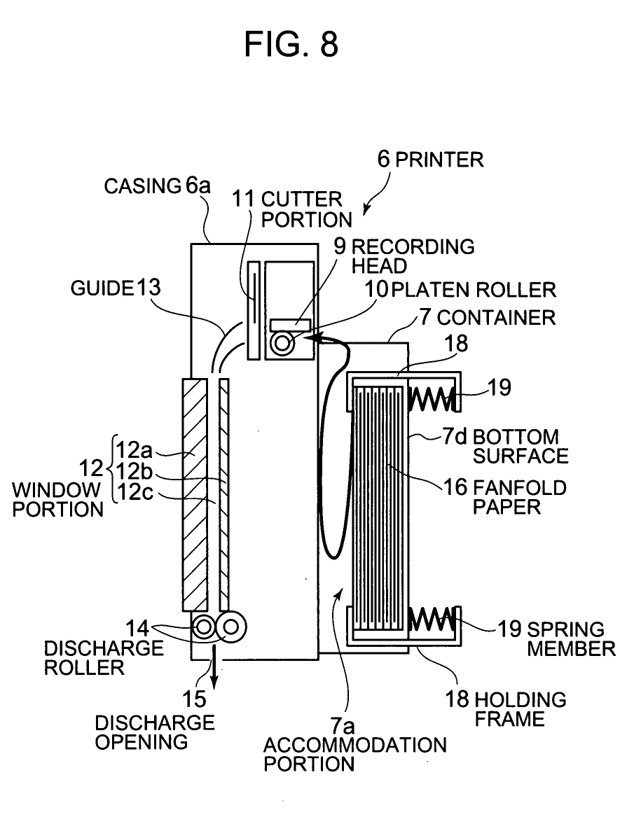

FIG. 8 shows a printer 6 for an electronic voting apparatus according to a third embodiment of the present invention. The printer 6 is provided with an urging mechanism for urging the fanfold paper 16 accommodated in the accommodation portion 7a of the container 7. The urging mechanism includes holding frames 18 for holding an upper surface of the fan fold paper 16, and spring members 19 mounted to the holding frames 18 and the main body of the container 7, and has a structure in which the holding frames 18 urge the fanfold paper 16 by a spring force of the spring members 19 against the bottom surface 7d of the accommodation portion 7a. Thus, even when the electronic voting apparatus 1 including the base surface 3a and the container 7 as shown in FIG. 2A (FIG. 2B) is inclined, the fanfold paper 16 is held without buckling or toppling over by the self weight, so the whole fan fold paper 16 can be smoothly transported with a small transport load. It should be noted that the bottom surface 7d of the container 7 mentioned in this specification is a surface positioned on an opposite side of the uppermost portion of the fanfold paper 16 to be drawn out at the feeding of the sheets, irrespective of the posture of the printer 6 when the printer 6 is used, and is a surface (right side surface shown in FIG. 8) which is brought into contact with and supports the large-area flat surface (main surface) of the lowermost portion of the fanfold paper 16 that is layered. In other words, the bottom surface 7d is normally an inner surface of the container 7 which is mainly subjected to the self weight of the fanfold paper 16 when the fanfold paper 16 is accommodated in the container 7. Structures other than the structure described above are similar to those of the first embodiment, and the electronic voting method is completely the same as that of the first embodiment (see FIG. 5).

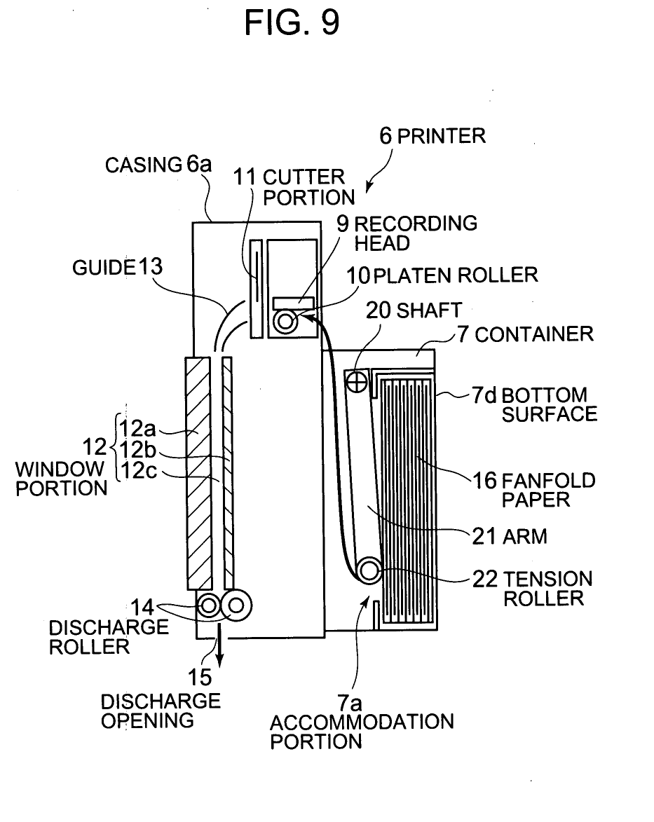

FIG. 9 shows a printer 6 for an electronic voting apparatus according to a fourth embodiment of the present invention. The printer 6 includes an urging mechanism composed of an arm 21 which is pivotable about the shaft 20, a tension roller 22 mounted to the free end of the arm 21, and an urging member (not shown) such as a spring member for urging the free end of the arm 21 against the bottom surface 7d of the accommodation portion 7a. With the structure, the tension roller 22 holds the upper surface of the fanfold paper 16, thereby holding the fanfold paper 16 against the bottom surface 7d of the accommodation portion 7a. Thus, similar to the third embodiment, even when the electronic voting apparatus 1 is inclined, the fanfold paper 16 is held without buckling or toppling over by the self weight. As a result, it is possible to smoothly transport the whole fanfold paper 16 with a small transport load. It should be noted that the other structures are the same as those of the first embodiment, and the electronic voting method is also completely the same as that of the first embodiment (see FIG. 5).

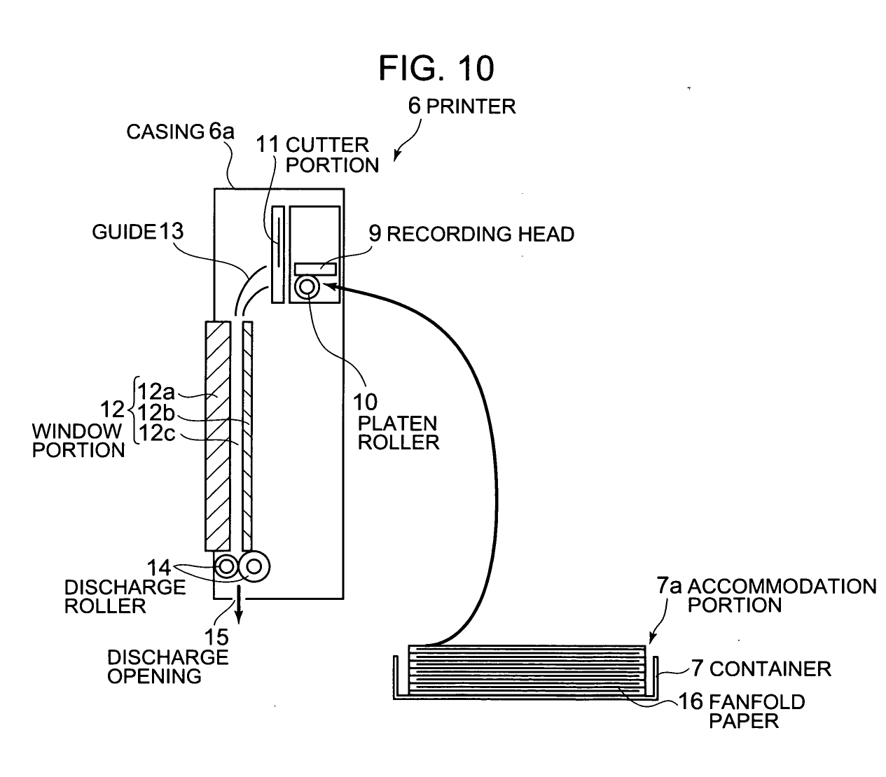

FIG. 10 shows a printer 6 for an electronic voting apparatus according to a fifth embodiment of the present invention. The container 7 of the printer 6 is provided to be separated from the casing 6a and is directly located on the floor. Accordingly, the fanfold paper 16 is horizontally held, and it is possible to transport the whole fanfold paper 16 with a small transport load without buckling or toppling over by the self weight. According to this embodiment, however, the printer 6 cannot be handled integrally as one unit. It should be noted that the other structures are the same as those of the first embodiment, and the electronic voting method is completely the same as that of the first embodiment (see FIG. 5).

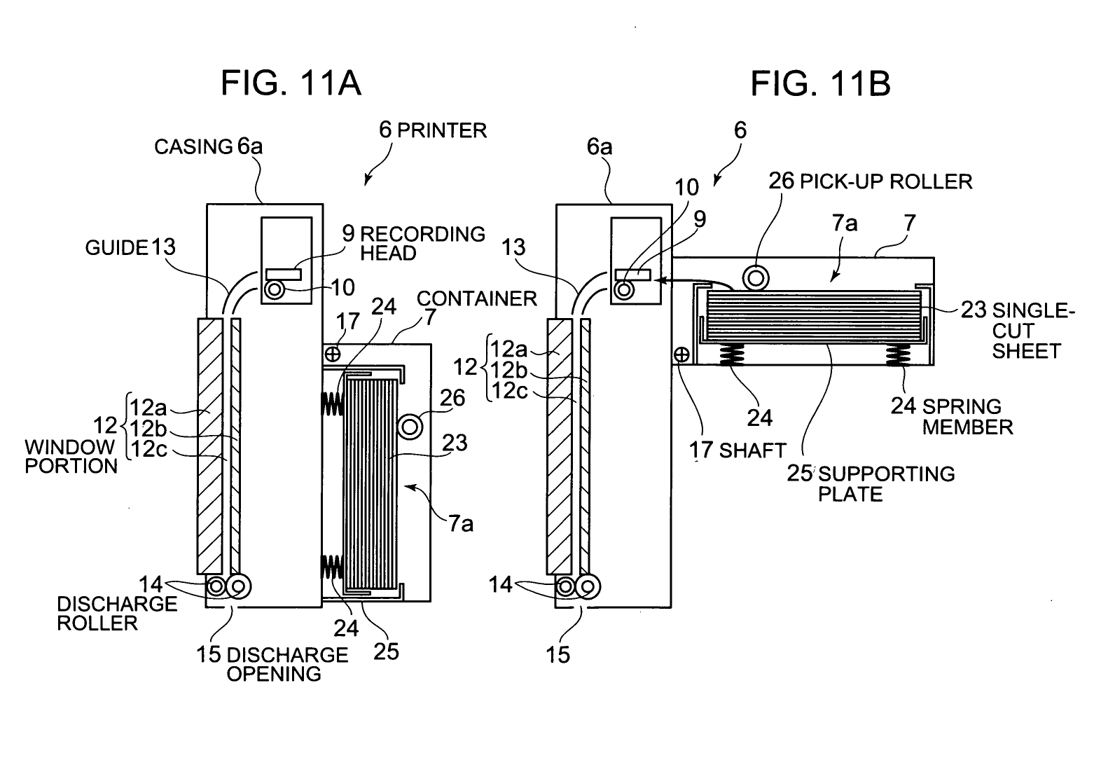

FIG. 11 shows a printer 6 for an electronic voting apparatus according to a sixth embodiment of the present invention. Similar to the second embodiment, the container 7 of the printer 6 is pivotable about a shaft 17. At the non-operating (accommodated) time of the printer, the container 7 is vertically arranged and brought into close contact with the casing 6a as shown in FIG. 11A, and at the operating (used) time of the printer 6, the container 7 is horizontally held as shown in FIG. 11B. According to this embodiment, instead of the fanfold paper 16, a plurality of single-cut sheets 23 are accommodated and stacked in the accommodation portion 7a. The single-cut sheets 23 are held by a support mechanism composed of spring members 24 and a supporting plate 25, and specifically, is located on the supporting plate 25 supported by the spring members 24 to be held. In addition, a pick-up roller 26 is provided at a position where the pick-up roller 26 is brought into contact with the upper surface of the uppermost single-cut sheet 23. Thus, at the operating time of the printer 6, the pick-up roller 26 takes out the single-cut sheets 23 one by one to feed the single-cut sheets 23 to the print portion. At this time, the main surface (flat surface) of the single-cur sheet 23 is located orthogonally to the direction of the self weight, so a bundle of the single-cut sheets 23 is held without buckling or toppling over by the self weight. Further, when the number of the single-cut sheets 23 remained in the container 7 is decreased, the single-cut sheets 23 can be picked up so that the upper surface of the uppermost single-cut sheet 23 is brought into contact with the pickup roller 26 by means of the spring members 24 and the supporting plate 25, thereby making it possible to smoothly transport the whole sheets with a small transport load. In addition, at the non-operating time of the printer 6, the container 6 is arranged to be upright, which eliminates needless space. It should be noted that in the case of the structure, it is not necessary to provide the cutter portion 11. The other structures are the same as those of the first embodiment. The electronic voting method according to this embodiment is completely the same as that of the first embodiment (see FIG. 5) except that a cutting process (Step S7) is not required.

What is claimed is:

1. A printer for an electronic voting apparatus, comprising:
a container for holding fanfold paper layered by being alternately folded every predetermined length as a recording sheet to be supplied to a casing of the printer;
a print portion arranged in the casing, for performing printing on a part of the fanfold paper supplied from the container;
a cutter portion arranged in the casing, for cutting off a portion of the fanfold paper printed by the print portion;
a window portion of the casing which is provided on a downstream side of the print portion with respect to a moving direction of the fanfold paper, through which the printed portion of the fanfold paper can be viewed from an outside; and
a discharge opening of the casing provided on a downstream side of the window portion with respect to the moving direction of the fanfold paper, for discharging the printed portion of the fanfold paper which has been cut off by the cutter portion.

2. A printer for an electronic voting apparatus according to, claim 1, further comprising an urging mechanism, in the container, for urging the fan fold paper against a bottom surface of the container.

3. A printer for an electronic voting apparatus, comprising:
a container for holding a plurality of single-cut sheets stacked as recording sheets to be supplied to a casing of the printer;
a print portion arranged in the casing, for performing printing on the single-cut sheets supplied from the container;
a window portion of the casing provided on a downstream side of the print portion with respect to a moving direction of the single-cut sheet, through which the printed single-cut sheet can be viewed from an outside; and
a discharge opening of the casing provided on a downstream side of the window portion with respect to the moving direction of the single-cut sheet, for discharging the printed single-cut sheet.

4. A printer for an electronic voting apparatus according to claim 3, further comprising:
a pick-up roller arranged in the container and brought into contact with an uppermost single-cut sheet among the plurality of single-cut sheets stacked; and
a support mechanism for holding the plurality of single-cut sheets stacked while urging the single-cut sheets against the pick-up roller.

5. A printer for an electronic voting apparatus according to claim 1, wherein the container is mounted to the casing.

6. A printer for an electronic voting apparatus according to claim 5, wherein the container takes a posture parallel to the casing at a non-operating time of the printer for an electronic voting apparatus, and takes a posture inclined with respect to the casing at an operating time of the printer for an electronic voting apparatus.

7. A printer for an electronic voting apparatus according to claim 6, a bottom surface of the container is in parallel with a horizontal plane at the posture inclined with respect to the casing.
